(19) United States
(12) Patent Application Publication
(10) Pub. No.: US 2025/0083842 A1
(43) Pub. Date: Mar. 13, 2025

(54) METHODS AND SYSTEMS FOR CHARGING AND SHELTERING DRONES

(71) Applicant: DISH Network Technologies India Private Limited, Bengaluru (IN)

(72) Inventor: Vikram Balaraja Shetty, Bengaluru (IN)

(21) Appl. No.: 18/463,459

(22) Filed: Sep. 8, 2023

(51) Int. Cl. B64U 80/25; B60L 53/14; B64U 70/90; G05D 1/10

(52) U.S. Cl. CPC B64U 80/25; B60L 53/14; B64U 70/90; B60L 2200/10

(57) ABSTRACT

A technique is directed to methods and systems for managing multiple unmanned aerial vehicles (UAVs). In some implementations, the method includes (1) receiving, by a server, a request for accommodating a UAV in an area; (2) generating, by the server, a list of available sheltering systems located in the area; (3) determining, by the server, a candidate system from the list of available sheltering systems at least based on a location of the UAV; (4) transmitting, by the server, information regarding the candidate system to the UAV; and (5) instructing, by the server, the candidate system to provide guidance information to the UAV when the candidate system detects that the UAV is in a distance between the candidate system. The guidance information includes information collected from a sensing component of the candidate system.

### BACKGROUND

Usage of drones for delivery and research is increasing recently. Due to range capacities, these drones cannot travel too far and charging can be an issue. Users need to manually land their drones first and then charge them with chargers. The foregoing issue substantially limits drones' abilities for long range delivery. In addition, Also, drones can be damaged due to some severe weather conditions if drone operators do not respond immediately. Therefore, it is advantageous to have an improved system and method to address the foregoing needs.

### BRIEF DESCRIPTION OF THE DRAWINGS

FIG. 1A is a schematic diagram illustrating a system for charging and sheltering drones in accordance with some implementations of the present disclosure.

FIGS. 1B and 1C are schematic diagrams illustrating systems for charging and sheltering drones in accordance with some implementations of the present disclosure.

FIGS. 2A and 2B are schematic diagrams illustrating landing mechanisms of the systems in accordance with some implementations of the present disclosure.

FIG. 3 is a block diagram illustrating an overview of devices on which some implementations can operate.

FIG. 4 is a block diagram illustrating an overview of an environment in which some implementations can operate.

FIGS. 5 and 6 are flow diagrams illustrating processes in some implementations in accordance with the present disclosure.

The techniques introduced here may be better understood by referring to the following Detailed Description in conjunction with the accompanying drawings, in which like reference numerals indicate identical or functionally similar elements.

### DETAILED DESCRIPTION

The present disclosure are directed to methods and systems for managing/operating drones or unmanned aerial vehicles (UAVs). More particularly, the present technology provides systems located at an existing structure (e.g., antennae towers for wireless communication, transmission towers, etc.) for charging and sheltering drones/UAVs.

The present system includes (1) a platform component; (2) a storage component; (3) a charging component, and (4) a control unit. The platform component is configured to (i) receive a drone (or UAV) upon arrival and enable the drone to launch or take off when departure. The system can also have sensors (such as camera, distance/location sensors, radar, etc.) configured to provide information and guidance for the drone to land on the platform component.

The storage component is configured to store and accommodate the drone when the drone is located in the system. The charging unit is configured to charge the drone. The control unit is configured to control other components of the system as well as communicate with the drone and/or external devices (e.g., a server, a smartphone, a portable device, a remote computer, etc.). In some embodiments, the present system can be located/incorporated in a telecommunication tower (e.g., a 5G base station).

In some embodiments, a drone can be instructed to access the present system based on instructions of an operator; a planned route; a triggering event such as a weather forecast indicating a specific weather condition, etc.

For example, a drone can be instructed to approach a predetermined charging system at a specific time according to a travel plan, such that the drone can be fully charged. In this example, the drone can communicate with the predetermined system via a remote server and provide updates regarding the drone's current status (location, current power status, traveling speed, loads, communication frequency/channels, etc.). In some embodiments, the drone can communicate with the predetermined system directly.

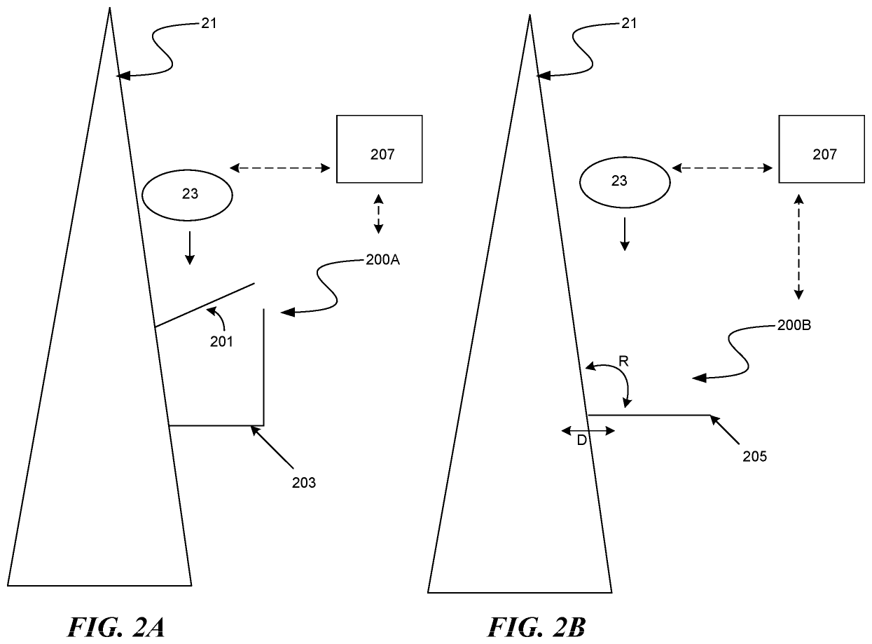

Once the drone approaches the predetermined system, a platform component of the predetermined charging system can initiate a receiving process. The platform component can be a structure that enables the drone to land on. In some embodiments, the platform component can extend from the system to create a surface for the drone to land on. In some embodiment, the platform component can be revealed by removing a cover of the system. Embodiments of the platform component are discussed in detail with reference to FIGS. 2A and 2B.

After the drone lands on the platform component, the drone can then be moved to a storage component. In some embodiments, the storage component can be a container that provides a shelter to the drone so as to prevent the drone from external weather or environmental conditions (e.g., cold, heat, wind, dust, electric fields, undesirable particles, etc.).

When the drone is located in the storage component, the drone can be provided with access to the charging component. Based on a pre-determined charging plan and/or a charging authorization from the control unit, the drone can then be charged. Once the charging process is complete, the drone can be prepared for departure. The control unit can communicate with the drone and run some check-ups to make sure the drone is ready to travel. The drone can then be moved from the storage component to the platform component for departure.

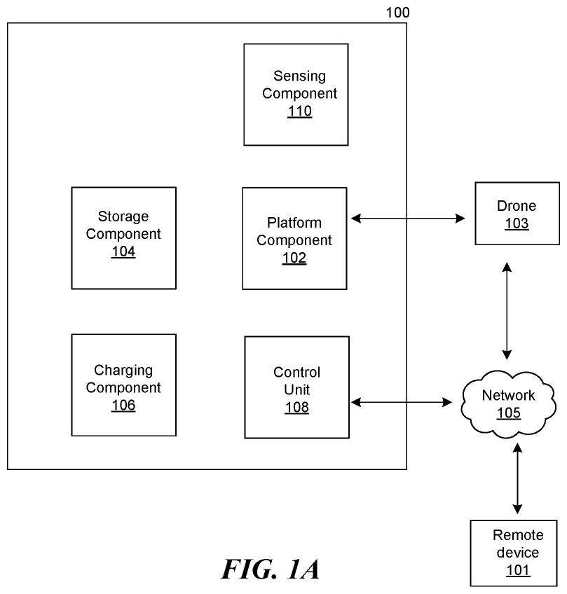

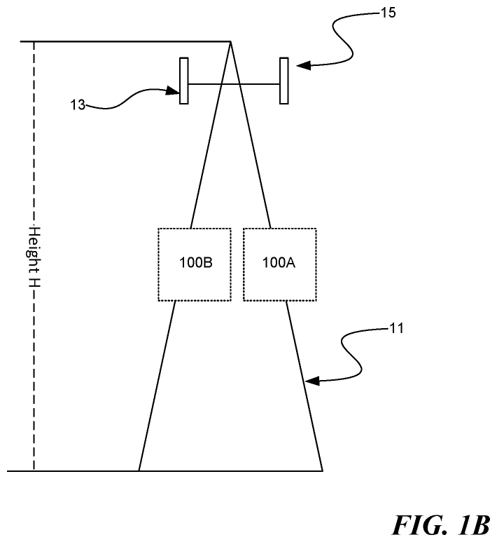

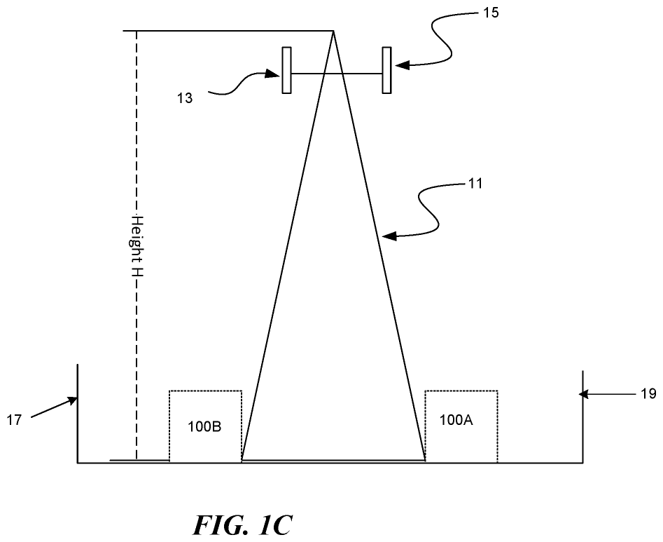

Several implementations are discussed below in more detail in reference to the figures. FIG. 1A is a schematic diagram illustrating a system 100 for charging and sheltering drones in accordance with some implementations of the present disclosure. The system 100 is configured to charge and shelter a drone 103. The system 100 can communicate with the drone via a remote device 101 through a network 105. The remote device 101 can be a server, a computer, a portable device, a smartphone, etc. The remote device 101 enables an operator of the drone 103 to communicate and control the drone 103. In some embodiments, the network 105 can be the Internet. In some embodiments, the network 105 can be a 5G network or a satellite network.

As shown, the system 100 includes a platform component 102, a storage component 104, a charging component 106, and a control unit 108. The platform component 102 is configured to receive the drone 103 upon its arrival. The control unit 108 is configured to control other components of the system 100 as well as communicate with the drone and/or external devices (e.g., a server, a smartphone, a portable device, a remote computer, etc.). In some embodiments, the system 100 can be located/incorporated in a telecommunication tower (e.g., a 5G base station).

The system 100 can also include one or more sensing components 110 configured to collect information regarding the drone 103 and then provide guidance/information for the drone 103 to land on the platform component 102 accordingly. In some embodiments, the sensing components 110 can include a camera, distance/location sensors, a radar, an infrared sensor, a lidar, an air pressure sensor, an airflow sensor, etc.

In some embodiments, the drone 103 can be instructed to access the system 100 based on instructions of an operator (e.g., from the remote device 101) or a planned route (e.g., stored in the drone 103 or from the remote device 101). In some embodiments, the drone 103 can approach the system 100 for an incident, unexpected charging (e.g., an unexpected battery malfunction) or possible repair (e.g., due to a component failure in the drone 103). In some embodiments, the drone 103 can approach the system 103 due to a triggering event such as a weather event/forecast indicating an inclement/bad/severe weather condition, etc.

For example, in response to a severe weather condition detected in a planned route of the drone 103, an operator of the drone 103 can instruct the drone 103 (e.g., via the remote device 101) to take shelter and wait for further instructions. In this case, the drone can then move toward the system as soon as possible.

Once the drone 103 approaches the system 100, the platform component 102 can initiate a receiving/landing process for the drone 103. The system 100 can first collect information regarding the drone 103 by the sensing component 110 (e.g., images of the drone, distance/location/ground speed, etc.) as well as by communicating with the drone 103 (e.g., distance/location/ground speed, current battery level, planned route, planned stay time, etc.). In some embodiments, the system 100 can provide guidance to the drone 103 regarding how to land on the platform component 102 (e.g., landing at which angle/direction, with certain speed, current wind speed, etc.).

The platform component 102 can be a moveable, rotatable flat surface or a structure that enables the drone 103 to land on. In some embodiments, the platform component can extend from the system to create a surface for the drone to land on (embodiments shown in FIG. 2B). In some embodiment, the platform component 102 can be revealed by removing a cover of the system (embodiments shown in FIG. 2A). Designs of the platform component 102 can vary based on the characteristics of the structure that the system 100 is located. In some embodiments, the platform component 102 can include an adjustment component (e.g., a roller, a robotic arm, etc.) to facilitate positioning the drone 103 after its landing.

For example, the system 100 can be located at a 5G antenna tower on top of a building. The system 100 can be shaped and sized to fit in the 5G antenna tower as well as the building. In the illustrated embodiment, the system 100 can provide guidance to the drone 103 regarding how to land on the platform component 102 without interfering the communications of the 5G antenna tower and avoid hitting the building. The system 100 can also provide similar guidance when the drone 103 departs from the platform component 102.

The storage component 104 is configured to store and accommodate the drone 103 when the drone is located in the system 100. In some embodiment, the drone 103 can directly land in the storage component 104 (e.g., the storage component 104 can be a box, whose bottom surface can be the platform component 102). In some embodiments, the drone 103 can first land on the platform component 102 (e.g., a structure extending from the storage component 104) and then be moved into the storage component 104 (e.g., via a convey component such as a belt and/or a track).

In some embodiments, the system 100 can have multiple storage components 104 such that the system can accommodate multiple drones 103. In some embodiments, there can be multiple systems 100 located in the same structure (e.g., one facing east, one facing north, etc.). In some embodiments, the storage component can be a container that provides a shelter to the drone so as to prevent the drone from external weather or environmental conditions (e.g., cold, heat, wind, dust, electric fields, undesirable particles, etc.).

The charging unit 106 is configured to charge the drone 103. When the drone is located in the storage component 104, the drone 103 can be provided with access to the charging component 106. In some embodiments, the charging component 106 can be a wired charging component (including cables, arms, connectors, adapters, etc.). For example, the charging component 106 can include a USB charging port and a robotic arm configured to align/facilitate the charging process (e.g., insert/remove a charging cable to the drone 103).

In some embodiments, the charging component 106 can be a wireless charging component (e.g., in compliance with wireless charging protocols such as Qi, Power Matters Alliance (PMA) standard, Alliance for Wireless Power (A4WP) standard, iNPOFi protocol, Wi-Po protocol, etc.). Based on a pre-determined charging plan and/or a charging authorization from the control unit 108, the drone 103 can then be charged by the charging component 106.

In some embodiments, multiple drones can be charged at the same time. In such embodiments, the control unit 108 manage/control charging rates of two or more charging components 106 according to energy availability or other suitable factors. In some embodiments, the control unit 108 can prioritize the charging processes at the two or more charging components based on, for example, a predetermined protocol, subscription plans, characteristics/purposes of the drones (e.g., for emergency, for scheduled tours, low battery power (e.g., lower than 10% of fully capacity), etc.

In some embodiments, the charging for the drone 103 can be implemented based on a service plan, a prepaid program, a reward program, etc. In some embodiments, the charging can be on a “walk-in” basis and to be paid by the operator of the drone 103. Once the charging process is complete, the drone 103 can be prepared for departure.

The control unit 108 can communicate with the drone 103 and run some check-ups (e.g., safety checks, battery capacity checks, route planning checks, destination check, etc.) so as to make sure the drone 103 is ready to travel as planned. The drone 103 can then be moved to/by the platform component 102 for departure.

FIGS. 1B and 1C are schematic diagrams illustrating systems for charging and sheltering drones in accordance with some implementations of the present disclosure. FIG. 1B shows an antenna tower 11 with height “H” and having two antenna 13, 15 installed on the top. In some embodiments, the height H can range from 50-200 feet. As shown, there can be two drone sheltering/charging systems 100A, 100B located in the middle section of the antenna tower 11 (e.g., at around ½ H). By this arrangement, the systems 100A, 100B are located far enough from the antenna 13, 15 such that the operations of the systems 100A, 100B do not interfere with the transmission/reception of the antenna 13, 15. In some embodiments, there can be more than two systems incorporated in the antenna tower 11.

In the embodiments shown in FIG. 1C, the systems 100A, 100B can be located on the side of the antenna tower 11. To provide protection for the systems 100A, 100B, two protection components 17, 19 can be installed adjacent to the systems 100A, 100B, respectively. In some embodiments, the protection components 17, 19 can include a fence, a baffle, a cover, etc. In some embodiments, the protection components 17, 19 can be formed with a height larger than the size of the systems 100A, 100B. In some embodiments, the protection components 17, 19 can be flush with the systems 100A, 100B. In some embodiments, the protection components 17, 19 can be folded (e.g., by hinges, hydraulic mechanisms, etc.) to further protect the systems 100A, 100B. In such implementations, the protection components 17, 19 can act as a “cover” for the systems 100A, 100B such that the systems 100A, 100B can “reveal” or “hide” their platform components (e.g., 102) in various operations.

FIGS. 2A and 2B are schematic diagrams illustrating landing mechanisms of the systems in accordance with some implementations of the present disclosure. As shown in FIG. 2A, a structure 21 can include a sheltering/charging system 200A installed. The system 200A is configured to shelter and charge a UAV 23. As shown, the system 200A includes a cover 201 and a container 203. When the cover 201 is at an open position, access to the container 203 is provided to the UAV 23. When the cover 203 is at a closed position, the container 203 is secured so the UAV 23 can be positioned therein safely. The cover 201 shown in FIG. 2A is in the process of moving from the closed position to the open position.

Referring to FIG. 2B, the structure 21 can include a sheltering/charging system 200B installed. The system 200B is configured to shelter and charge the UAV 23. As shown, the system 200B includes an extendable platform component 205 configured to let the UAV 23 to land on. In some embodiments, the extendable platform component 205 can be moved/retreated in direction D. In some embodiments, the extendable platform component 205 can be rotated in direction R.

When the extendable platform component 205 is at an open position (as illustrated in FIG. 2B), the UAV 23 can land on the extendable platform component 205. After the UAV 23 has landed on the extendable platform component 205, the UAV 23 can be secured (e.g., by a clip, a holding member, a magnet, any other suitable mechanism, etc.) and then moved to be stored. In some embodiments, the UAV 23 can be moved (along with the extendable platform component 205) in direction D and can be stored inside the structure 21. In some embodiments, the UAV 23 can be rotated (along with the extendable platform component 205) in direction R toward a closed position. The UAV 23 can then be stored inside the structure 21. When the UAV 23 is positioned inside the structure 21, the UAV 23 can be charged.

In some embodiments, when the UAV 23 is positioned inside the structure 21, the system 200A or 200B can communicate with the UAV 23. For example, the system 200A or 200B can perform tests/check-ups on the UAV 23. In some embodiments, the system 200A or 200B can provide firmware updates to and/or install applications on the UAV 23. In some embodiments, if there is any situation detected that worth further action or attention, the system 200A or 200B can notify an operator of the UAV 23.

In some embodiments, the system 200A or 200B can receive request for shelter from an external device (e.g., a server 207 that oversees multiple systems including the systems 200A and 200B). This can happen in response to a triggering event (e.g., a severe weather event, an emergency, a planned maintenance/charging, etc.). Upon receiving the request, the system 200A or 200B can report availability to the external device, and then the external device can further communicate with the UAV 23 and direct it to a suitable system based on various factors such as the locations of the UAV 23, the locations of the available system, remaining power of the UAV 23, location/during of the triggering event, etc.

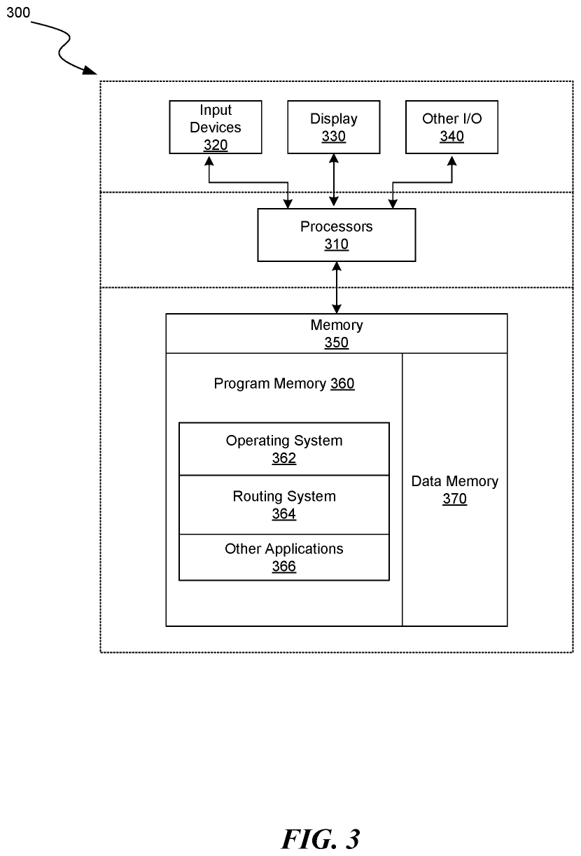

FIG. 3 is a block diagram illustrating an overview of devices (e.g., the remote device 101, the control unit 108, the drone 103, the UAV 23, the server 207 etc.) on which some implementations can operate. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. The device 300 can utilize the communication device to distribute operations across multiple network devices.

The processors 310 can have access to a memory 350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, routing system 364 (e.g., for implementing the routing plan discussed herein), and other application programs 366. The memory 350 can also include data memory 370, user interface data, event data, image data, biometric data, sensor data, device data, location data, network learning data, application data, alert data, structure data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

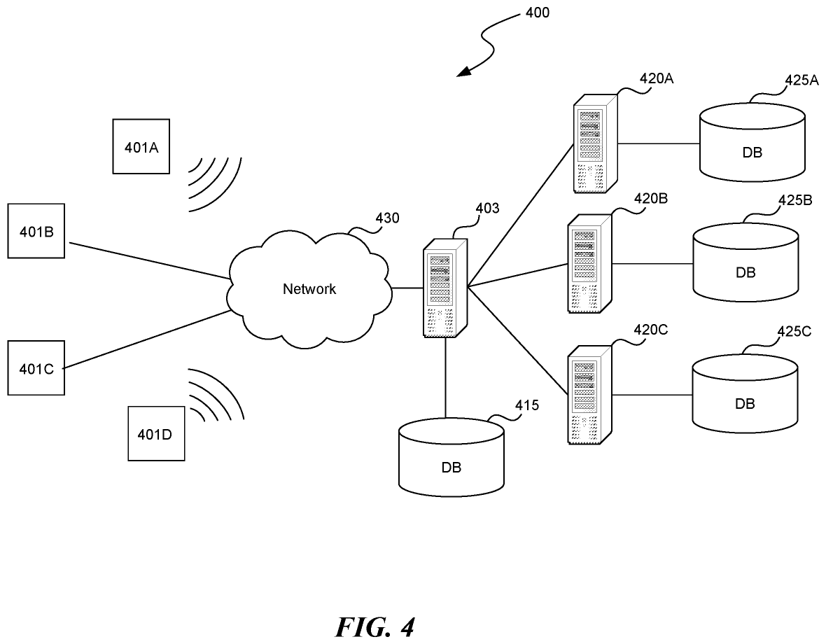

FIG. 4 is a block diagram illustrating an overview of an environment 400 in which some implementations can operate. The environment 400 can include one or more client computing devices 401A-D, examples of which can include the remote device 101, the control unit 108, the drone 103, the UAV 23, etc. The client computing devices 401 can operate in a networked environment using logical connections through network 430 to one or more remote computers, such as a server computing device 403.

In some implementations, the server computing device 403 can be an edge server which receives client requests and coordinates fulfillment of those requests through other servers, such as servers 420A-C. Server computing devices 403 and 420 can comprise computing systems, such as the device 300 discussed above. Though each server computing device 403 and 420 is displayed logically as a single server, server computing devices can each be a distributed computing environment encompassing multiple computing devices located at the same or at geographically disparate physical locations. In some implementations, each server 420 corresponds to a group of servers.

The client computing devices 401 and the server computing devices 403 and 420 can each act as a server or client to other server/client devices. Server 403 can connect to a database 415. Servers 420A-C can each connect to a corresponding database 425A-C. As discussed above, each server 420 can correspond to a group of servers, and each of these servers can share a database or can have their own databases.

The databases 415/425 can store information such as implement data, user interface data, event data, image data, detection data, biometric data, sensor data, device data, location data, network learning data, application data, alert data, structure data, camera data, retrieval data, management data, notification data, configuration data. Though databases 415/425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. The network 430 may be the Internet or some other public or private network. The client computing devices 401 can be connected to the network 430 through a network interface, such as by wired or wireless communication. While the connections between server 403 and servers 420 are shown as separate connections, these connections can be any kind of local, wide area, wired, or wireless network, including network 430 or a separate public or private network.

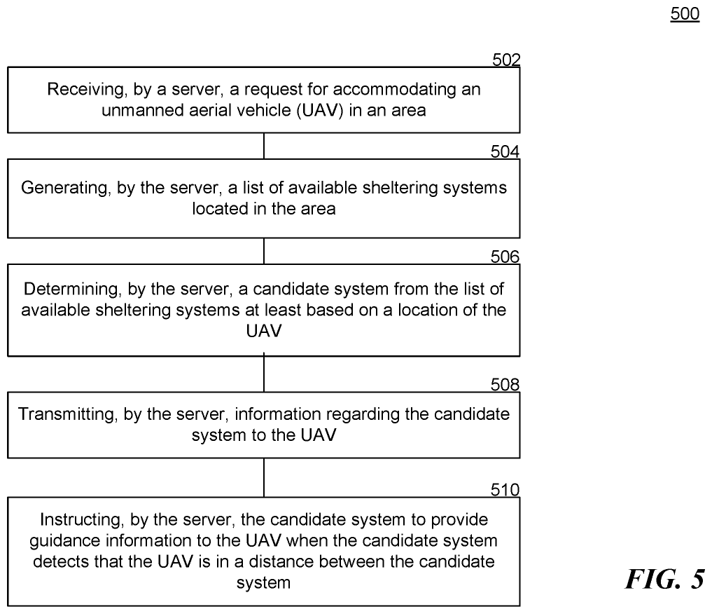

FIG. 5 is a flow diagram illustrating a method 500 used in some implementations for managing multiple UAVs. In some embodiments, the method 500 can be implemented by a sever (e.g., the server 207) discussed herein.

At block 502, the method 500 start by receiving, by a server, a request for accommodating an unmanned aerial vehicle (UAV) in an area.

At block 504, method 500 continues by generating, by the server, a list of available sheltering systems located in the area.

At block 506, method 500 continues by determining, by the server, a candidate system from the list of available sheltering systems at least based on a location of the UAV

At block 508, method 500 continues by transmitting, by the server, information regarding the candidate system to the UAV

At block 510, method 500 continues by instructing, by the server, the candidate system to provide guidance information to the UAV when the candidate system detects that the UAV is in a distance between the candidate system. In some embodiments, the guidance information includes information collected from a sensing component of the candidate system.

In some embodiments, the candidate system includes a platform component configured to enable the UAV to land on. In some embodiments, the platform component is movable between an open position and a closed position. In some embodiments, the candidate system includes a storage component configured to accommodate the UAV.

In some embodiments, the candidate system includes a cover configured to enable the UAV to arrive and depart, wherein when the cover is at an open position, the candidate system is accessible to the UAV.

In some embodiments, the candidate system includes a charging component configured to charge the UAV. In some embodiments, the charging component includes a wireless charging component. In some embodiments, the charging component includes a wired charging component. In some embodiments, the candidate system includes a control unit configured to communicate with and provide the guidance information for the UAV.

In some embodiments, the sensing component includes a camera, and the information collected from the sensing component includes an image of the UAV. In some embodiments, the sensing component includes a distance sensor, and the information collected from the sensing component includes a distance between the UAV and the candidate system.

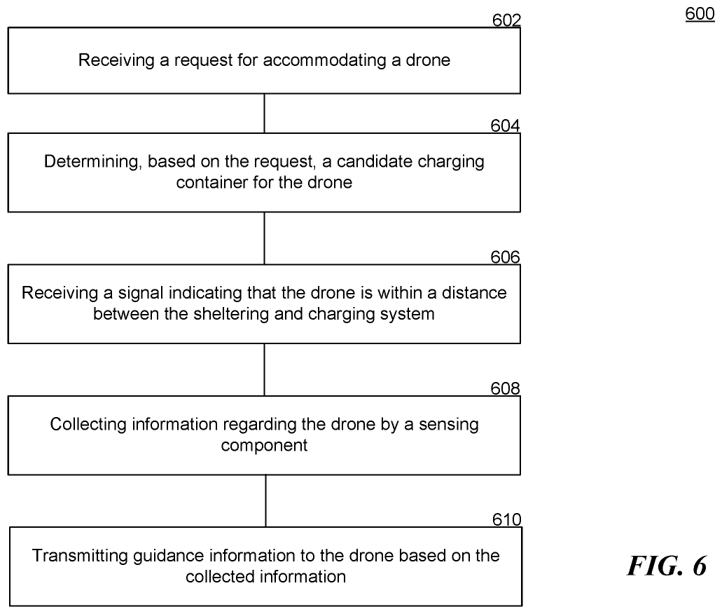

FIG. 6 is a schematic diagram illustrating a method 600 for operating a sheltering and charging system. The method 600 can be implemented by a charging and sheltering system discussed herein (e.g., the system 100, 100A, 100B, 200A, or 200B).

At block 602, the method 600 continues by receiving a request for accommodating a drone. At block 604, the method 600 proceeds by, determining, based on the request, a candidate charging container for the drone. At block 606, the method 600 continues by receiving a signal indicating that the drone is within a distance between the sheltering and charging system

At block 608, the method 600 continues by collecting information regarding the drone by a sensing component. At block 610, the method 600 continues by transmitting guidance information to the drone based on the collected information. The sheltering and charging system includes a platform component configured to enable the drone to land on.

In some embodiments, the method 600 further comprising moving the platform component from a closed position to an open position so as to enable the drone to land on. In some embodiments, the method 600 further comprising rotating the platform component from a closed position to an open position so as to enable the drone to land on.

In some embodiments, the method 600 further comprising enabling a charging component to charge the drone when the drone is positioned in the candidate charging container. In some embodiments, the method 600 further comprising selecting the candidate charging container from a list of available candidate charging containers.

In some embodiments, the charging component includes a wireless charging component. In some embodiments, the charging component includes a wired charging component. In some embodiments, the sensing component includes a camera, and the information collected from the sensing component includes an image of the drone. In some embodiments, the sensing component includes a distance sensor, and the information collected from the sensing component includes a distance between the drone and the candidate charging container.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method, comprising:
receiving, by a server, a request for accommodating an unmanned aerial vehicle (UAV) in an area;
generating, by the server, a list of available sheltering systems located in the area;
determining, by the server, a candidate system from the list of available sheltering systems at least based on a location of the UAV;
transmitting, by the server, information regarding the candidate system to the UAV; and
instructing, by the server, the candidate system to provide guidance information to the UAV when the candidate system detects that the UAV is in a distance between the candidate system, wherein the guidance information includes information collected from a sensing component of the candidate system.

2. The method of claim 1, wherein the candidate system includes a platform component configured to enable the UAV to land on.

3. The method of claim 1, wherein the platform component is movable between an open position and a closed position.

4. The method of claim 1, wherein the candidate system includes a storage component configured to accommodate the UAV.

5. The method of claim 1, wherein the candidate system includes a cover configured to enable the UAV to arrive and depart, wherein when the cover is at an open position, the candidate system is accessible to the UAV.

6. The method of claim 1, wherein the candidate system includes a charging component configured to charge the UAV.

7. The method of claim 1, wherein the charging component includes a wireless charging component.

8. The method of claim 1, wherein the charging component includes a wired charging component.

9. The method of claim 1, wherein the candidate system includes a control unit configured to communicate with and provide the guidance information for the UAV.

10. The method of claim 1, wherein the sensing component includes a camera, wherein the information collected from the sensing component includes an image of the UAV, wherein the sensing component includes a distance sensor, and wherein the information collected from the sensing component includes a distance between the UAV and the candidate system.

11. A method of operating a sheltering and charging system, comprising:
receiving a request for accommodating a drone;
determining, based on the request, a candidate charging container for the drone;
receiving a signal indicating that the drone is within a distance between the sheltering and charging system;
collecting information regarding the drone by a sensing component; and
transmitting guidance information to the drone based on the collected information;
wherein the sheltering and charging system includes a platform component configured to enable the drone to land on.

12. The method of claim 11, further comprising moving the platform component from a closed position to an open position so as to enable the drone to land on.

13. The method of claim 11, further comprising rotating the platform component from a closed position to an open position so as to enable the drone to land on.

14. The method of claim 11, further comprising enabling a charging component to charge the drone when the drone is positioned in the candidate charging container.

15. The method of claim 14, wherein the charging component includes a wireless charging component.

16. The method of claim 14, wherein the charging component includes a wired charging component.

17. The method of claim 11, wherein the sensing component includes a camera, and wherein the information collected from the sensing component includes an image of the drone.

18. The method of claim 11, wherein the sensing component includes a distance sensor, and wherein the information collected from the sensing component includes a distance between the drone and the candidate charging container.

19. The method of claim 1, further comprising selecting the candidate charging container from a list of available candidate charging containers.

20. A system for sheltering and charging multiple drones, comprising:
a control unit configured to communicate with at least one drone of the multiple drones;
a platform component configured to enable the least one drone to land on by moving from a closed position to an open position;
a storage component configured to accommodate the at least one drone;
a charging component configured to charge the at least one drone when the at least one drone is positioned in the storage component;
a sensing component configured to collect information regarding the drone; and
a control unit configured to transmitting guidance information to the drone based on the collected information.
